(19) United States
(12) Patent Application Publication
(10) Pub. No.: US 2004/0088350 A1
(43) Pub. Date: May 6, 2004

(54) Method, system and program product for facilitating access to instrumentation data in a heterogeneous distributed system

(75) Inventor: Thomas A. Early, Clifton Park, NY (US)

Correspondence Address: HESLIN ROTHENBERG FARLEY & MESITI PC, 5 COLUMBIA CIRCLE, ALBANY, NY, 12203, US

(73) Assignee: General Electric Company

(21) Appl. No.: 10/285,225

(22) Filed: Oct. 31, 2002

(51) Int. Cl. G06F 15/16

(52) U.S. Cl. 709/203; 709/219

(57) ABSTRACT

Method, system and program product are provided for facilitating access to instrumentation data, such as nuclear magnetic resonance data, within a distributed system having one or more clients and one or more instrumentation servers. The facility includes receiving at an instrumentation server a request for instrumentation data from a client of the distributed system. The request is interpreted at the instrumentation server and instrumentation data in a local data structure is retrieved responsive thereto. The retrieved instrumentation data is then automatically converted from the local data structure of the instrumentation server to a predefined, common data structure for return to the requesting client. The distributed system may include multiple instrumentation servers and multiple clients, at least some of which could comprise heterogeneous environments.

A computer program listing on compact disc, containing Appendices A, B & C, is filed herewith and is incorporated herein by reference in its entirety. In particular, Appendix A is 14,564 bytes (16,384 bytes as stored on disk), Appendix B is 15,301 bytes (16,384 bytes as stored on disk), and Appendix C is 35,403 bytes (36,864 bytes as stored on disk). Appendices A, B & C were stored to the enclosed CD-ROM on Oct. 24, 2002 (i.e., date of creation).

A portion of the disclosure of this patent document contains material which is subject to copyright protection. The copyright owner, General Electric Company, has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The present invention relates generally to information retrieval within a heterogeneous distributed system, and more particularly, to facilitating access to instrumentation data, such as nuclear magnetic resonance data, within a distributed, heterogeneous environment having one or more clients and one or more analytical instrumentation systems with associated instrumentation servers.

Nuclear magnetic resonance (NMR) is a well-known phenomenon which occurs when nuclei of certain atoms are immersed in a static magnetic field and exposed to a second oscillating magnetic field. Certain nuclei experience the phenomenon, and others do not, depending upon whether they have a spin property. Nuclear magnetic resonance spectroscopy employs the NMR phenomenon to study physical, chemical and biological properties of matter. NMR spectroscopy finds applications in many areas of science and medicine. NMR spectrometers are similar to the magnetic resonance imaging systems common in hospitals today, yet use much stronger magnetic fields that are able to study much smaller samples than the human body. For example, NMR spectrometers allow scientists to determine the three-dimensional structure of molecules, even viewing molecules atom-by-atom.

Currently, there are numerous manufacturers of NMR spectrometers and associated scientific workstations. Because of this, current NMR data servers are a heterogeneous mixture, each typically employing its own data structure or format. This results in a problem when multiple heterogeneous NMR spectrometers are linked within a distributed system as to how NMR data can be shared among the different NMR sites, and how the NMR data may be remotely accessed, again employing a client system which may also be heterogeneous to one or more of the NMR server systems. Therefore, a need exists in the art for a method, system and program product for facilitating access to NMR data, or more generally, any instrumentation data, within such a heterogeneous, distributed environment.

### SUMMARY OF THE INVENTION

The present invention provides, in one aspect, a method of facilitating access to instrumentation data in a distributed system having at least one client and at least one instrumentation server. The method includes: receiving a request for instrumentation data from the at least one client at the at least one instrumentation server, the request having been received from across the distributed system; interpreting the request at the at least one instrumentation server and retrieving instrumentation data responsive thereto; and automatically converting the retrieved instrumentation data from a local data structure of the at least one instrumentation server to a common data structure for return to the at least one client.

In another aspect, a method of providing instrumentation data in a distributed system is presented. The distributed system again has at least one client and at least one instrumentation server. This method includes: receiving at the at least one instrumentation server a request from the at least one client for instrumentation data; interpreting the request and retrieving instrumentation data in a local data structure responsive thereto, the instrumentation data including header parameters and associated data; automatically translating and copying the header parameters from the local data structure to a header field of a common data structure; automatically translating and copying the associated data from the local data structure to a data field of the common data structure; and transmitting the header parameters and associated data in the common data structure from the at least one instrumentation server across the distributed system, for return to the at least one client.

In a further aspect, a method of facilitating access to nuclear magnetic resonance (NMR) data in a distributed system is provided. The distributed system includes multiple NMR clients and multiple NMR servers, wherein at least some of the multiple NMR clients and the multiple NMR servers are heterogeneous systems. This method includes: sending a request for NMR data from an NMR client of the multiple NMR clients to an NMR server of the multiple NMR servers across the distributed system; interpreting the request at the NMR server and retrieving NMR data responsive thereto; automatically converting the retrieved NMR data from a local data structure of the NMR server to a common binary data structure; and returning the NMR data in the common binary data structure across the distributed system to the NMR client sending the request.

Systems and computer program products corresponding to the above-summarized methods are also described and claimed herein. Further, other embodiments and aspects of the invention are also described in detail and claimed herein.

### BRIEF DESCRIPTION OF THE DRAWINGS

The present invention may take form in various components and arrangements of components, and in various steps and arrangement of steps. The drawings presented herewith are for purposes of illustrating certain embodiments and should not be construed as limiting the invention. The subject matter which is regarded as the invention is particularly pointed out and distinctly claimed in the claims at the conclusion of the specification.

FIG. 1 is a diagrammatic illustration of one embodiment of a heterogeneous, distributed system employing a data access facility in accordance with an aspect of the present invention;

FIG. 2 illustrates one embodiment of a two-way communication socket established between one NMR client and one NMR server of, for example, the heterogeneous, distributed system of FIG. 1 in accordance with an aspect of the present invention;

FIG. 3 is a flowchart of one embodiment of NMR client processing of a data access facility in accordance with an aspect of the present invention;

FIG. 4 is a flowchart of one embodiment of NMR client data reception and translation processing in accordance with an aspect of the present invention;

FIG. 5 is a flowchart of one embodiment of NMR server processing of a data access facility in accordance with an aspect of the present invention; and

FIG. 6 is a flowchart of one embodiment of NMR server data conversion and transmission responsive to a client request for instrumentation data in accordance with an aspect of the present invention.

### DETAILED DESCRIPTION OF THE INVENTION

Although described herein with reference to NMR spectroscopy and NMR servers, the facility disclosed is applicable to the sharing of other types of instrumentation data of heterogeneous analytical instrumentation systems. A distributed system of heterogeneous NMR spectrometers is one example of a distributed system comprising multiple heterogeneous analytical instrumentation systems, and should not be read as limiting the scope of the claims presented herewith.

As noted, there are numerous manufacturers of nuclear magnetic resonance (NMR) spectrometers and associated scientific workstations. This results in NMR data servers that are a heterogeneous mixture, each typically employing its own data structure or format. A problem thus results when multiple such NMR spectrometers are linked within a distributed system, i.e., how to efficiently share NMR data among different NMR sites, and remotely access NMR data using one or more clients. Disclosed herein is an approach for facilitating the sharing and accessing of NMR data within such a heterogeneous, distributed system.

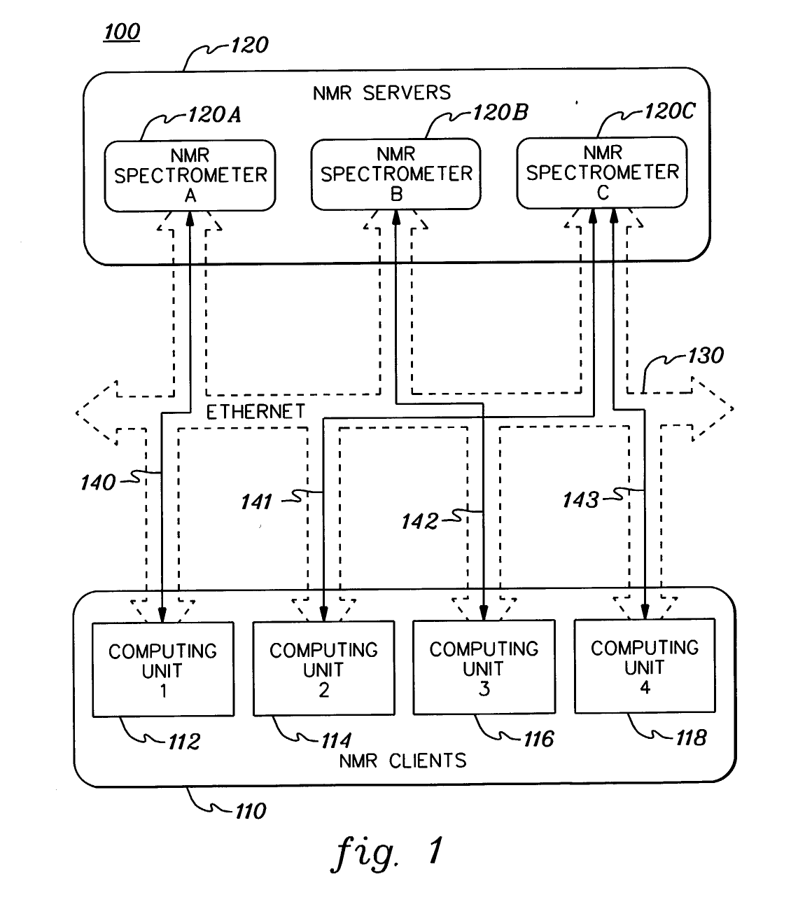

FIG. 1 depicts one example of a distributed system 100 to employ a data access facility in accordance with an aspect of the present invention. System 100 is a client-server data distribution network which includes multiple NMR clients 110 and multiple NMR servers 120 linked together employing, for example, an Ethernet based distribution network 130. By way of example, the Ethernet distribution network could comprise the Internet, or a local area network. Although shown as a collection, the NMR servers 130, including NMR spectrometer A 120A, NMR spectrometer B 120B and NMR spectrometer C 120C, could be remotely located from each other, and at least some of the spectrometers are assumed to comprise heterogeneous spectroscopy systems, which, for example, may have been produced by different manufacturers. Each NMR spectrometer has at least one associated NMR server which facilitates the retrieval of NMR spectral data of that spectrometer as described further below.

NMR client computing units 112, 114, 116 and 118 are shown by way of example. Each one of these computing units could comprise a remote computing unit, such as a PC based computing system which is linked to the data distribution network 130, for accessing NMR data of one or more of the NMR spectrometers 120. Multiple two-way communication links are shown established between the computing units and the NMR spectrometers. Specifically, link 140 is established between computing unit 112 and NMR spectrometer A, link 141 between NMR spectrometer 120C and computing unit 114, link 142 between NMR spectrometer 120B and computing unit 116, and link 143 between NMR spectrometer 120C and computing unit 118. By way of example, each of these communication links could comprise a transient, two-way TCP/IP socket which is a well known communication link to those skilled in the art.

Disclosed herein is a facility for allowing a user employing any one of the NMR clients 112, 114, 116, 118 to access NMR data disposed at any one of the NMR spectrometers 120A, 120B, 120C, at least some of which are assumed posses their own, local NMR data format. In addition, one or more of the NMR clients may comprise a heterogeneous system to the systems of the NMR spectrometers. The facility disclosed hereinbelow allows a client user to readily, and in real time, access NMR data without need for the user to actively assist in any reformatting or translation of the NMR data from the local format of the originating spectrometer to a local format or structure of the client computing unit.

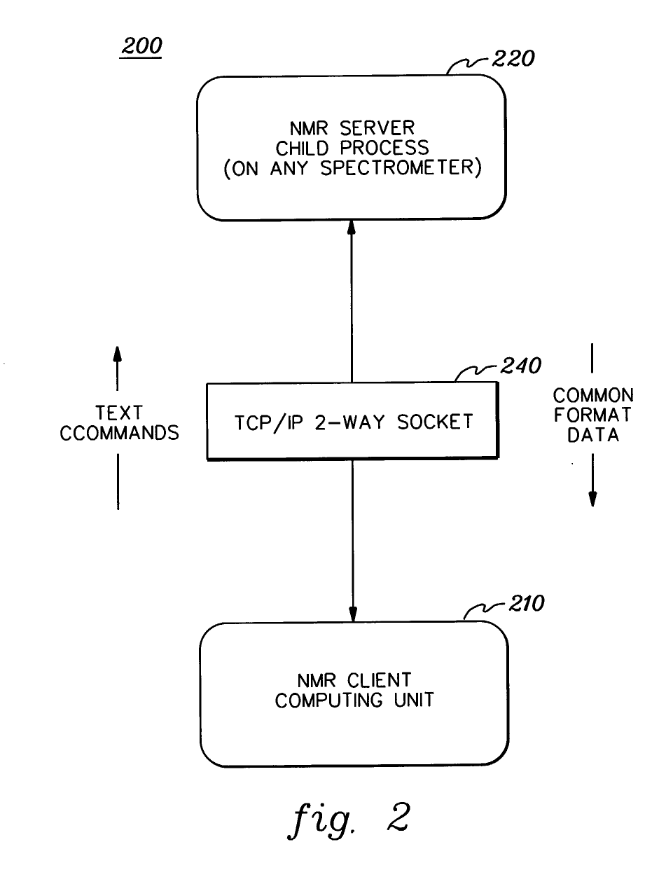

FIG. 2 illustrates a feature of the data access facility disclosed herein. In this figure, a heterogeneous, distributed system 200 is again assumed, with only one NMR client 210 and one NMR server 220 associated with a spectrometer being shown. A child process of the NMR server is established to communicate with the NMR client via a TCP/IP two-way socket 240. The NMR client forwards text commands to the NMR server for retrieval of NMR data in accordance with an aspect of the present invention. Before the data is returned to the requesting client, an automatic and transparent conversion of the data occurs from the local data structure of the NMR server 220 to a predefined, common binary data structure. This common, binary data exchange format facilitates the transportation of the NMR data from the NMR server to the client and relieves the user of any active participation in a data translation process.

As an example, NMR data servers would listen on dedicated NMR TCP/IP ports for requests for data or information from one or more clients within the distributed system. An NMR client located anywhere on the network places a request for information to an NMR server, again disposed anywhere on the network, using the server's NMR TCP/IP port. The respective NMR server receives the request and, after validating the source of the request, transparently formats the requested NMR data to a common data structure. Each NMR server is pre-programmed with processing to reformat the data from its native, or local data structure, to the common data structure, and examples of this reformatting processing are provided in the Appendices contained within the incorporated Computer Program Listing Appendix on Compact Disc. The reformatted NMR data is then sent as TCP/IP package streams to the requesting client over the NMR port. As this stream is received, the client may perform any necessary reformatting to convert the common data structure to a native or local data structure used by the client. Here again, the client knows how to convert the common data structure to its local data structure format, i.e., if necessary.

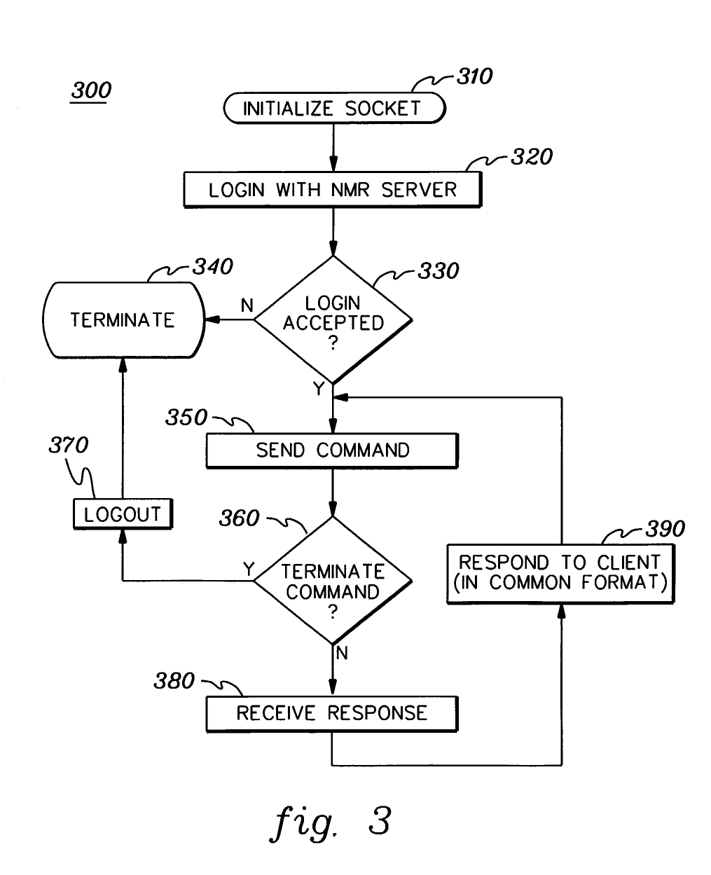

FIG. 3 depicts one flowchart embodiment of processing implemented at an NMR client of a heterogeneous, distributed system, in accordance with an aspect of the present invention. This processing, generally denoted 300, is a command loop wherein a socket is initialized 310, and the NMR client attempts to login with a desired NMR server 320. This could involve the use of standard handshaking protocol over a TCP/IP socket. Processing determines whether the login is accepted 330, and if “no”, the connection is terminated 340. Assuming that the NMR client successfully logs in with an NMR server, then a text command is sent 350 from the NMR client to the NMR server. Table 1 depicts examples of various text commands that could be employed by the NMR client pursuant to a facility in accordance with an aspect of the present invention.

TABLE 1

| Command String | Server Response |
|---|---|
| /<directory> | Change current directory to <directory>. |
| ?<filename> | Test if <filename> exists on server. |
| <filename> | Get <filename>, translate to common format and |
| | transmit it. |
| 1 | List all files and directories in the current directory |
| | and transmit that list. |
| L | List only NMR spectra files and directories in the |
| | current directory and transmit that list. |
| X | Terminate connection. |
| umswinuser, <host> | Accept login from client named <host>. |

Continuing with FIG. 2, processing determines whether the current command is a terminate connection command 360, and if so, the client system and server system logout 370 and the connection is terminated 340. Assuming that the command is other than a terminate command, then the NMR client awaits receipt of a response to the client command via the TCP/IP pipe established between the NMR server and the NMR client 380. Once the response is received, the NMR client acts on the response received 390. The action depends upon the client command sent. By way of example, the action might simply be to display retrieved information for a user of the NMR client. After acting on the response, the client processing loop returns to send a next client command 350.

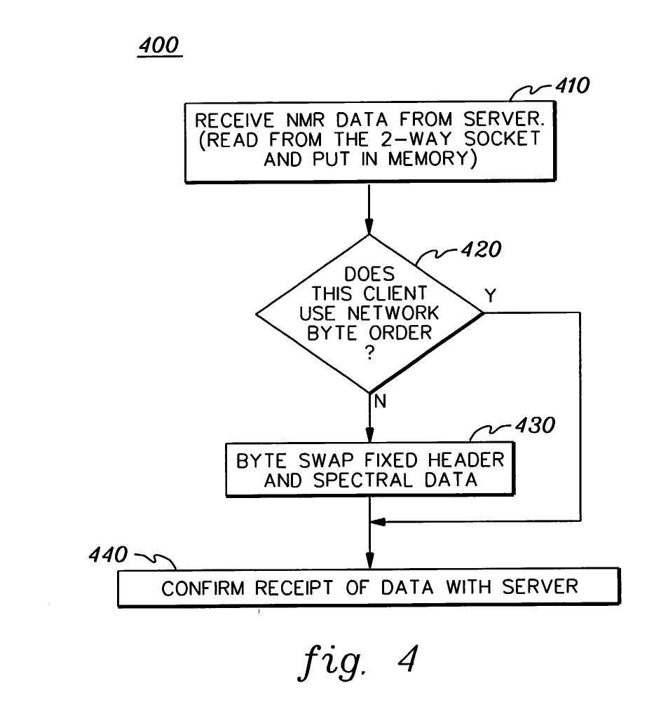

FIG. 4 depicts one embodiment of NMR client data reception and translation processing 400, which may be implemented by the NMR client. Processing embodiment 400, which is optional depending upon the particular NMR client, begins with receipt of TCP/IP NMR data from the server 410, i.e., NMR data is read from the two-way socket and placed into memory at the NMR client. Depending upon whether the particular NMR client employs the network byte order 420, a byte swap may be necessary for the NMR data received 430. As described further below, the NMR data may comprise a fixed header and associated spectral data, which would need to be byte swapped depending upon the particular implementation of the NMR client receiving the data. This byte swapping is a well known function in the art, and can be accomplished by calling a routine available at the operating system of the NMR client. For example, the NTOH subroutine could be employed within a UNIX based system to achieve the byte swapping. The NMR client confirms receipt of the NRM data from the server by sending an appropriate reply back 440.

Turning to the NMR servers, and as noted above, the data access facility disclosed herein employs an automatic data conversion at the NMR server to translate retrieved NMR data from the local data structure of the NMR server to a common data structure. Appendix A, comprising part of the Computer Program Listing Appendix on Compact Disc, presents one detailed example of a common data structure definition which can be provided to the NMR servers of the heterogeneous, distributed system.

Briefly summarized, the common data structure of Appendix A provides a specific example of a data structure for an NMR distribution system implementation. The intrinsic data types, i.e., character strings of specific length, single (4-byte) and double precision (8-byte) floating point and integer values are assumed to be in “network byte ordering” for an Ethernet based system. This means that the highest order byte is first, and the lowest order byte appears last. The common data structure includes three general fields, i.e., a fixed header, a flexible header and a spectral data field. The fixed header, in one embodiment, comprises 1181 bytes of intrinsic data that describe certain common parameters used in the experimental acquisition of the associated NMR data. The phrase “common parameters” means those parameters conventionally employed by NMR spectrometers of different manufacturers. The flexible header field is provided for any number of additional, unique parameters that may be available with a particular type of NMR spectrometer. These unique parameters may be described in three consecutive null-terminated strings: “name”, “type” and “value”. The flexible header items are not described in the fixed header. The spectral data is a vector of the intrinsic data. The length of the vector is specified as a parameter in the fixed header.

Although described further hereinbelow with reference to the above summarized common data structure, those skilled in the art will recognize that the data access facility disclosed is applicable to other common data structure formats.

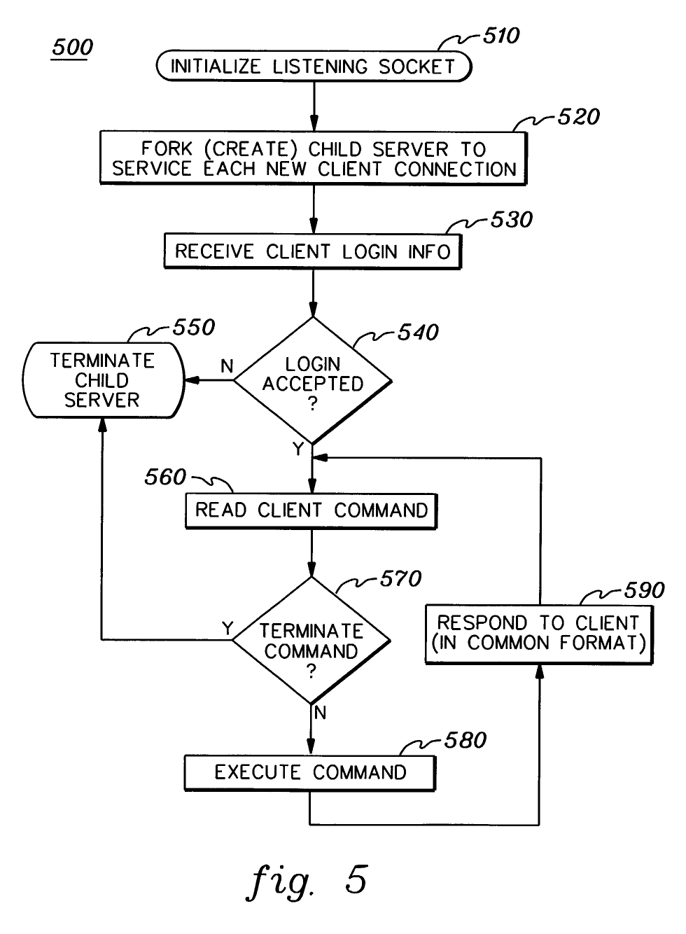

FIG. 5 depicts one embodiment of NMR server processing 500 in accordance with an aspect of the present invention. This processing loop begins with the NMR server initializing a listening socket 510; that is, the parent connection of a TCP/IP socket sits waiting for a connection request from an NMR client. When such a request is received, the NMR server creates a child server process to service the new client connection 520. This processing is referred to as a Fork in UNIX based systems, upon which many NMR spectrometers are based. The NMR server receives the client login information 530 and determines whether the login is accepted 540. If the login is invalid, then the NMR server terminates the child process 550. Otherwise, the client's text command (see Table 1) is read 560 and processing determines whether the received text command is a terminate command from the NMR client 570. If so, the child process is terminated at the NMR server 550. Assuming that the text command is other than a terminate command, then the NMR server executes the command 580. Execution of the command could involve translation of the received text string command from the NMR client to an internal operating system command of the server, which can be readily accomplished by those skilled in the art. Once the command is executed, NMR data is retrieved and formatted in response to the command 590. This formatting automatically includes converting the NMR data from the local data structure of the NMR server to the defined, common data structure (e.g., See Appendix A of the Computer Program Listing Appendix on Compact Disc) for forwarding across the network to the NMR client.

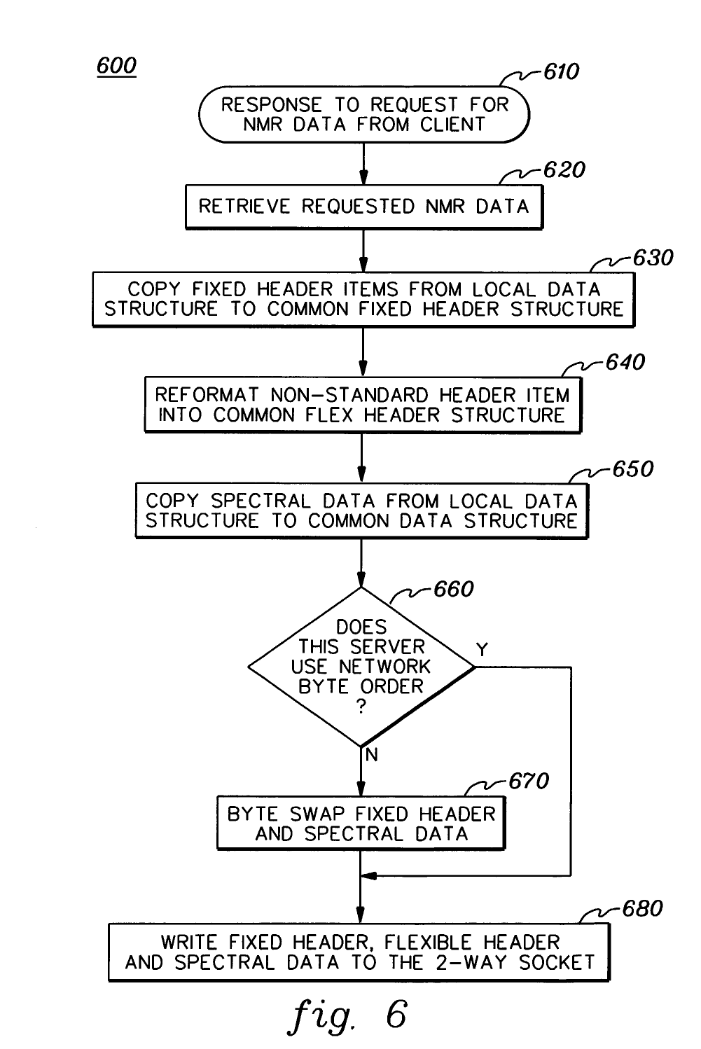

FIG. 6 depicts one process embodiment 600 of NMR server data conversion and transmission responsive to a client command 610. This processing 600 includes retrieving the requested NMR data 620, and translating and copying fixed header items of the data from the local data structure of the NMR server to a common fixed header structure 630. As noted above, the NMR data (or more generally any instrumentation data) is assumed to comprise both header information and associated spectral data. The header information includes the parameters employed in collecting the spectral data. This NMR data, when retrieved, is in the format of the of the particular NMR server retaining the information, and therefore, the actual formatting of the data depends upon the particular NMR spectrometer. However, most if not all, NMR spectrometers have certain common parameters which are employed in collecting the spectral data. These common parameters, such as spectral width, dwell times, etc., are placed into a fixed header field in the common data structure 630.

In addition, various NMR spectrometers have certain parameters or other items which are not standard across all NMR spectrometer manufacturers. These non-standard (or manufacturer unique) items are placed into a flex header field 640. By way of example, non-standard items might comprise information related to various text-type strings, where an NMR sample originated, traceability information, etc. The flex header within the common data structure is designed to take any information that is not already defined in the common fixed header field. Thus, all header parameters for a particular NMR server are placed either into the fixed header field or the flex header field of the common data structure.

Next, the associated spectral data is converted from the local data structure to a data field of the common data structure 650. This converting of the spectral data from one format to another may involve rearranging the data depending upon the particular NMR spectrometer implementation. Although the processing required to convert from the local data format to the common data format is dependent on the particular NMR spectrometer type, those skilled in the art can implement software to accomplish this conversion given the information disclosed herein. By way of further explanation and example, Appendix B discloses processing for translating from a local data format to a common data format for a General Electric type NMR spectrometer, while Appendix C discloses processing for converting from a local data format to a common data format for a Brugger type NMR spectrometer. Both Appendix B and Appendix C are part of the Computer Program Listing Appendix on Compact Disc included herewith.

After conversion to the common data structure, processing determines whether the NMR server uses the network byte order 660. If “no”, then a byte swap of the fixed header, flex header and spectral data 670 is performed, e.g., using HTON in UNIX. Thereafter, the fixed header, flexible header and spectral data is written to the two-way socket established between the NMR server and the NMR client requesting the data 680.

Those skilled in the art will note from the above discussion that presented herein is a data access facility, implemented, for example, in both NMR clients and NMR servers which allows an NMR client to retrieve NMR data from an NMR server transparent to any data conversion during the retrieval process. The facility includes a user visible program at the client which facilitates the rapid exchange, processing and plotting of NMR data, and an invisible program to the user which resides on the NMR servers that act as sources of NMR data streams, serving NMR data to clients anywhere in the world on the distributed network in a common data exchange format.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of facilitating access to instrumentation data in a distributed system comprising at least one client and at least one instrumentation server, said method comprising:
receiving a request for instrumentation data from the at least one client at the at least one instrumentation server, the request having been received from across the distributed system;
interpreting the request at the at least one instrumentation server and retrieving instrumentation data responsive thereto; and
automatically converting the retrieved instrumentation data from a local data structure of the at least one instrumentation server to a common data structure for return to the at least one client.

2. The method of claim 1, further comprising receiving the instrumentation data in the common data structure at the at least one client and translating the common data structure into a local data structure of the at least one client.

3. The method of claim 1, wherein the at least one instrumentation server comprises multiple instrumentation servers, and wherein at least some instrumentation servers of the multiple instrumentation servers comprise heterogeneous server environments.

4. The method of claim 3, wherein the at least one client comprises a heterogeneous system to at least one instrumentation server of the multiple instrumentation servers.

5. The method of claim 4, wherein the multiple instrumentation servers are associated with respective analytical instrumentation systems.

6. The method of claim 5, wherein the at least some heterogeneous server environments store instrumentation data utilizing different respective local data structures.

7. The method of claim 5, wherein the multiple analytical instrumentation systems comprise multiple nuclear magnetic resonance spectrometers.

8. The method of claim 7, wherein the instrumentation data comprises nuclear magnetic resonance data, including header parameters and spectral data associated therewith.

9. The method of claim 1, wherein the instrumentation data in the common data structure is returned to the at least one client in real time responsive to the request for instrumentation data sent across the distributed system to the at least one instrumentation server.

10. The method of claim 1, wherein the converting is performed transparent to the at least one client.

11. The method of claim 1, wherein the common data structure is a binary data format.

12. A method of providing instrumentation data in a distributed system comprising at least one client and at least one instrumentation server, said method comprising:
receiving at the at least one instrumentation server a request from the at least one client for instrumentation data;
interpreting the request and retrieving instrumentation data responsive thereto, the instrumentation data comprising header parameters and associated data;
automatically translating and copying the header parameters from a local data structure to a header field of a common data structure;
automatically translating and copying the associated data from the local data structure to a data field of the common data structure; and
transmitting the header parameters and associated data in the common data structure from the at least one instrumentation server across the distributed system, for return to the at least one client.

13. The method of claim 12, wherein the header translating and copying comprises translating and copying at least one standard header parameter from the local data structure into a common fixed header field and translating and copying at least one non-standard header parameter from the local data structure into a common flex header field, and wherein the transmitting includes writing the fixed header, flexible header and data field in the common data structure across the distributed system.

14. The method of claim 12, further comprising determining, prior to forwarding of the common data structure, whether the at least one instrumentation server employs a byte order corresponding to a byte order of the distributed system, and if not, byte swapping the common data structure fields into the byte order of the distributed system for forwarding to the at least one client.

15. The method of claim 12, wherein the at least one client comprises a heterogeneous system to the at least one instrumentation server.

16. The method of claim 12, wherein the instrumentation data comprises nuclear magnetic resonance data, and wherein the header and associated data translating and copying to the common data structure are transparent to the at least one client.

17. A method of facilitating access to nuclear magnetic resonance (NMR) data in a distributed system comprising multiple NMR clients and multiple NMR servers, wherein at least some of the multiple NMR clients and the multiple NMR servers comprise heterogeneous systems, said method comprising:
sending a request for NMR data from an NMR client of the multiple NMR clients to an NMR server of the multiple NMR servers across the distributed system;
interpreting the request at the NMR server and retrieving NMR data responsive thereto;
automatically converting the retrieved NMR data from a local data structure of the NMR server to a common binary data structure; and
returning the NMR data in the common binary data structure across the distributed system to the NMR client sending the request.

18. The method of claim 17, wherein the converting is transparent to the NMR client sending the request.

19. The method of claim 18, wherein the converting comprises copying at least one standard header parameter from the local data structure to a common fixed header structure, copying at least one non-standard header parameter from the local data structure to a common flex header structure, and copying requested NMR spectral data from the local data structure to a spectral data field of the common binary data structure.

20. The method of claim 17, further comprising predefining the common binary data structure to be used by the multiple NMR servers when responding to NMR data requests from the multiple NMR clients.

21. A system for facilitating access to instrumentation data in a distributed system, said system comprising:
at least one client adapted to send a request for instrumentation data across the distributed system to at least one instrumentation server;
the at least one instrumentation server being adapted to interpret the request and retrieve instrumentation data responsive thereto; and
wherein the at least one instrumentation server is further adapted to automatically convert the retrieved instrumentation data from a local data structure of the at least one instrumentation server to a common data structure for return to the at least one client.

22. The system of claim 21, wherein the at least one client comprises multiple clients, and wherein the at least one instrumentation server comprises multiple instrumentation servers, and wherein at least some instrumentation servers of the multiple instrumentation servers comprise heterogeneous server environments.

23. The system of claim 22, wherein the at least some heterogeneous server environments store instrumentation data utilizing different respective local data structures.

24. The system of claim 23, wherein the multiple instrumentation servers are associated with respective analytical instrumentation systems, the analytical instrumentation systems comprising multiple nuclear magnetic resonance spectrometers.

25. The system of claim 21, wherein the at least one instrumentation server is adapted to convert the retrieved instrumentation data from the local data structure to the common data structure transparent to the at least one client requesting the instrumentation data, and wherein the common data structure is a binary data format.

26. A system for providing instrumentation data in a distributed system comprising at least one client and at least one instrumentation server, said system comprising:
receiving means at the at least one instrumentation server for receiving a request from the at least one client for instrumentation data;
retrieval means for interpreting the request and retrieving instrumentation data responsive thereto, the instrumentation data comprising header parameters and associated data in a local data format of the at least one instrumentation server;
converting means for automatically translating and copying the header parameters from the local data structure to a header field of a common data structure, and the associated data from the local data structure to a data field of the common data structure; and
transmitting means for writing the header parameters and associated data in the common data structure across the distributed system to the at least one client.

27. The system of claim 26, wherein the converting means comprises translating and copying at least one standard header parameter from the local data structure into a common fixed header field and translating and copying at least one non-standard header parameter from the local data structure into a common flex header field of the common data structure, and wherein the transmitting means includes writing means for writing the fixed header, flexible header and data field in the common data structure across the distributed system.

28. The system of claim 26, further comprising byte order means for determining, prior to writing of the common data structure, whether the at least one instrumentation server employs a byte order corresponding to a byte order of the distributed system, and if not, for byte swapping the common data structure fields into the byte order of the distributed system for forwarding to the at least one client.

29. The system of claim 26, wherein the at least one client comprises a heterogeneous system to the at least one instrumentation server.

30. The system of claim 26, wherein the instrumentation data comprises nuclear magnetic resonance data, and wherein the header and associated data translating and copying to the common data structure is transparent to the at least one client.

31. A system for facilitating access to nuclear magnetic resonance (NMR) data comprising:
a distributed system comprising multiple NMR clients and multiple NMR servers, wherein at least some of the multiple NMR clients and the multiple NMR servers comprise heterogeneous environments within the distributed system, said system for facilitating access to NMR data comprising:
request means for sending a request for NMR data from an NMR client of the multiple NMR clients to an NMR server of the multiple NMR servers across the distributed system;
retrieval means for interpreting the request at the NMR server and retrieving NMR data responsive thereto;
translation means for automatically converting the retrieved NMR data from a local data structure of the NMR server to a common binary data structure; and
transmitting means for returning the NMR data in the common binary data structure across the distributed system to the NMR client sending the request.

32. The system of claim 31, wherein the translation means comprises means for converting the retrieved NMR data from the local data structure of the NMR server to the common binary data structure transparent to the NMR client sending the request.

33. The system of claim 32, wherein the translation means comprises copy means for copying at least one standard header parameter from the local data structure to a common fixed header structure, for copying at least one non-standard header parameter from the local data structure to a common flex header structure, and for copying requested NMR spectral data from the local data structure to a spectral data field of the common binary data structure.

34. The system of claim 31, further comprising system means for predefining the common binary data structure to be used by the multiple NMR servers when responding to a data request from one or more of the multiple NMR clients.

35. At least one program storage device readable by a machine, tangibly embodying at least one program of instructions executable by the machine to perform a method of facilitating access to instrumentation data in a distributed system comprising at least one client and at least one instrumentation server, the method comprising:
receiving a request for instrumentation data from the at least one client at the at least one instrumentation server, the request having been received from across the distributed system;
interpreting the request at the at least one instrumentation server and retrieving instrumentation data responsive thereto; and
automatically converting the retrieved instrumentation data from a local data structure of the at least one instrumentation server to a common data structure for return to the at least one client.

36. The at least one program storage device of claim 35, wherein the at least one client comprises multiple clients, and wherein the at least one instrumentation server comprises multiple instrumentation servers, and wherein at least some instrumentation servers of the multiple instrumentation servers comprise heterogeneous server environments.

37. The at least one program storage device of claim 36, wherein the at least some heterogeneous server environments store instrumentation data utilizing different respective local data structures, and wherein the multiple instrumentation servers are associated with respective analytical instrumentation systems.

38. The at least one program storage device of claim 37, wherein the multiple analytical instrumentation systems comprise multiple nuclear magnetic resonance spectrometers.

39. The at least one program storage device of claim 35, wherein the at least one instrumentation server converts the retrieved instrumentation data from the local data structure to the common data structure transparent to the at least one client requesting the instrumentation data, and wherein the common data structure is a binary data format.

40. At least one program storage device readable by machine, tangibly embodying at least one program of instructions executable by the machine to perform a method of providing instrumentation data in a distributed system comprising at least one client and at least one instrumentation server, the method comprising:
receiving at the at least one instrumentation server a request from the at least one client for instrumentation data;
interpreting the request and retrieving instrumentation data responsive thereto, the instrumentation data comprising header parameters and associated data;
automatically translating and copying the header parameters from a local data structure to a header field of a common data structure;
automatically translating and copying the associated data from the local data structure to a data field of the common data structure; and
transmitting the header parameters and associated data in the common data structure from the at least one instrumentation server across the distributed system, for return to the at least one client.

41. The at least one program storage device of claim 40, wherein the header translating and copying comprises translating and copying at least one standard header parameter from the local data structure into a common fixed header field and translating and copying at least one non-standard header parameter from the local data structure into a common flex header field, and wherein the transmitting includes writing the fixed header, flexible header and data field in the common data structure across the distributed system.

42. The at least one program storage device of claim 40, wherein the at least one client comprises a heterogeneous system to the at least one instrumentation server, and wherein the instrumentation data comprises nuclear magnetic resonance data, and the header and associated data translating and copying to the common data structure are transparent to the at least one client.

43. At least one program storage device readable by machine, tangibly embodying at least one program of instructions executable by the machine to perform a method of facilitating access to nuclear magnetic resonance (NMR) data in a distributed system comprising multiple NMR clients and multiple NMR servers, wherein at least some of the multiple NMR clients and multiple NMR servers comprise heterogeneous systems, said method comprising:
sending a request for NMR data from an NMR client of the multiple NMR clients to an NMR server of the multiple NMR servers across the distributed system;
interpreting the request at the NMR server and retrieving NMR data responsive thereto;
automatically converting the retrieved NMR data from a local data structure of the NMR server to a common binary data structure; and
returning the NMR data in the common binary data structure across the distributed system to the NMR client sending the request.

44. The at least one program storage device of claim 43, wherein the converting is transparent to the NMR client sending the request.

45. The at least one program storage device of claim 44, wherein the converting comprises copying at least one standard header parameter from the local data structure to a common fixed header structure, copying at least one non-standard header parameter from the local data structure to a common flex header structure, and copying requested NMR spectral data from the local data structure to a spectral data field of the common binary data structure.
